(19) United States
(12) Patent Application Publication
(10) Pub. No.: US 2017/0219332 A1
(43) Pub. Date: Aug. 3, 2017

(54) TIME DOMAIN REFLECTOMETRY WAVEGUIDE

(71) Applicant: FINETEK Co., Ltd., New Taipei City (TW)

(72) Inventors: I-Chu LIN, New Taipei City (TW); Liang-Chi CHANG, New Taipei City (TW); Chao-Kai CHENG, New Taipei City (TW); Yao-Chen YU, New Taipei City (TW); Yi-Liang HOU, New Taipei City (TW)

(21) Appl. No.: 15/014,011

(22) Filed: Feb. 3, 2016

(51) Int. Cl. G01B 7/26

(52) U.S. Cl. CPC G01B 7/26

(57) ABSTRACT

A time domain reflectometry waveguide structure (1) includes: a control module (10) for transmitting a sensing signal and receiving a reflection signal fed back from the sensing signal; a waveguide sensor (20) connected to the control module (10) and including a first probe (21) connected to the control module (10), a curved probe (22) connected to the first probe (21) and a second probe (23) extended from the curved probe (22); a protective cover (30) coaxially sheathed on the first probe (21) and exposing the curved probe (22), and a sensing signal passing through the protective cover (30) and the first probe (21) without interference and transmitted to the curved probe (22) and the second probe (23) to obtain the reflection signal; and an insulator (40) covered onto the waveguide sensor (20) and the protective cover (30) to prevent interference, facilitate measurements, and measure environmental parameters of different media.

### FIELD OF THE INVENTION

The technical field relates to an apparatus for measuring the depth of an object under water, more particularly to a waveguide structure that uses a time domain reflectometry method to measure the depth of an object under water.

### BACKGROUND OF THE INVENTION

Time Domain Reflectometry (TDR) is a method using the transmission of electromagnetic waves for monitoring, detection and exploration. A transmission system of the electromagnetic waves uses a waveguide as a signal transmitting and sensing component. The design of the waveguide primarily converts the monitored environmental change parameter into a change of transmission signal (such as a reflection signal) of the waveguide, and to obtain an environmental change parameter from the reflection signal. In practice, the travel time of reflection signals generated in different environmental interfaces of the electromagnetic waves is measured, and then the speed of the electromagnetic waves and the travel time of the reflection signal are measured to locate a discontinuous position of the signal, so as to obtain an environmental change parameter.

Since a multiple of reflections are produced during the process of monitoring the transmission of electromagnetic waves (such as from air into water), therefore it is difficult to identify the reflection signal of the environmental parameter to be measured. In addition, signals are attenuated by the interference of foreign substances during the process of transmitting the electromagnetic waves. More importantly, when the electromagnetic waves are transmitted from an environment (such as water) with a high dielectric coefficient to an environment (such as soil or sludge) with a low dielectric coefficient, a full reflection occurs, so that an environmental parameter with a low dielectric coefficient cannot be detected or measured.

In view of the aforementioned problems of the prior art, the discloser of this disclosure based on years of experience in the related industry to conduct extensive researches and experiments, and finally provided a feasible solution to overcome the problems of the prior art.

### SUMMARY OF THE INVENTION

It is a primary objective of this disclosure to provide a time domain reflectometry waveguide structure to achieve the effects of preventing the interference of foreign substances, facilitating measurements, and measuring environmental parameters of different media.

To achieve the aforementioned and other objectives, this disclosure provides a time domain reflectometry waveguide structure comprising a control module, a waveguide sensor, a protective cover and an insulator. The control module is provided for transmitting a sensing signal and receiving a reflection signal fed back from the sensing signal. The waveguide sensor is electrically coupled to control module and includes a first probe coupled to the control module, a curved probe bent and coupled to the first probe, and a second probe extended from the curved probe. The protective cover is coaxially sheathed on the first probe and exposes the curved probe, and the sensing signal is passed through the protective cover and out from the first probe without being interfered, and then transmitted to the curved probe and the second probe to obtain a reflection signal. The insulator is covered onto the waveguide sensor and the protective cover.

Another objective of this disclosure is to provide a time domain reflectometry waveguide structure comprising a reference probe exposed from the insulator and disposed parallel to an edge of the first probe, and the curve of the reflection signal may be used as a reference for comparison for future related computation.

Compared with the conventional structure, the time domain reflectometry waveguide structure of this disclosure coaxially sheathes the protective cover onto a portion of the waveguide sensor, such that when the sensing signal passes through the protective cover, the signal is not interfered by external objects, so as to prevent the attenuation of the sensing signal. As a result, the waveguide sensor has a long-distance sensing capability. When the sensing signal is transmitted from an environment (such as water) with a high dielectric coefficient to an environment (such as soil or sludge) with a low dielectric coefficient, a full reflection occurs, so that the waveguide sensor can transmit the sensing signal to an environment with a low dielectric coefficient and generate a reflection signal to compute the material level/height successfully. In addition, this disclosure further comprises a reference probe exposed from the insulator, and the curve of the reflection signal may be used as a reference for comparison to facilitate future related computation.

### BRIEF DESCRIPTION OF THE DRAWINGS

FIG. 1A is a cross-sectional view of a time domain reflectometry waveguide structure of this disclosure;

FIG. 1B is a curve showing the signal intensity of a reflection signal before the detection made by a time domain reflectometry waveguide structure of this disclosure takes place;

FIG. 2A is a first schematic view of using a time domain reflectometry waveguide structure of this disclosure;

FIG. 2B is a curve showing the intensity of the reflection signal of FIG. 2A;

FIG. 3A is a second schematic view of using a time domain reflectometry waveguide structure of this disclosure;

FIG. 3B is a curve showing the intensity of the reflection signal of FIG. 3A;

FIG. 4 is a schematic view of a time domain reflectometry waveguide structure in accordance with another embodiment of this disclosure.

### DESCRIPTION OF THE PREFERRED EMBODIMENTS

The technical contents of this disclosure will become apparent with the detailed description of preferred embodiments accompanied with the illustration of related drawings as follows. It is intended that the embodiments and figures disclosed herein are to be considered illustrative rather than restrictive.

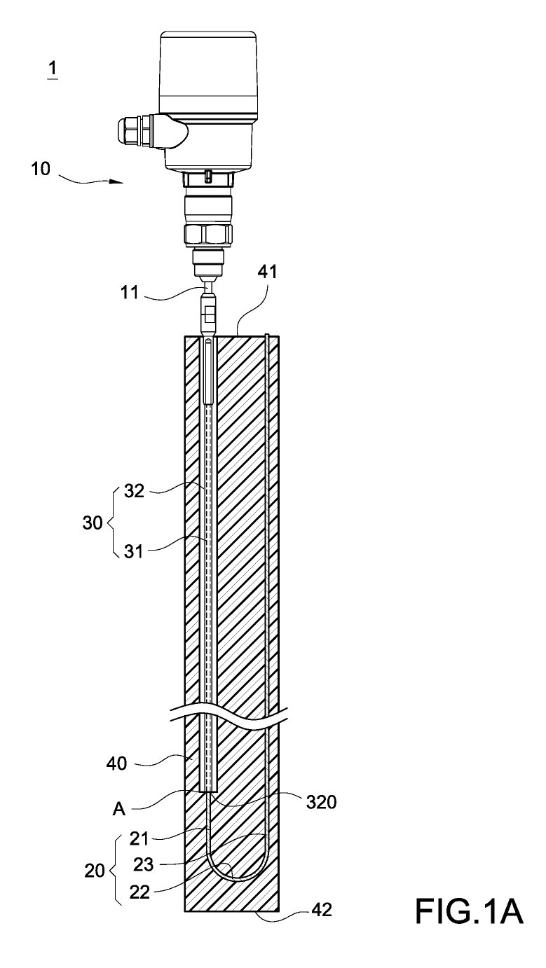

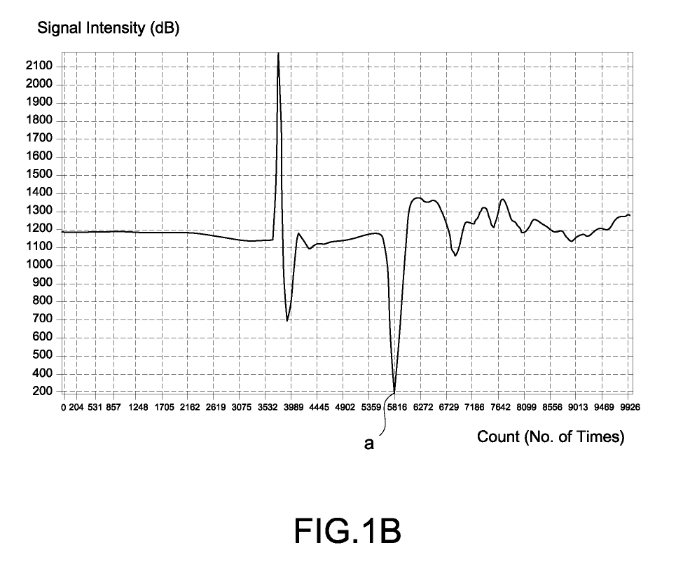

With reference to FIGS. 1A and 1B for a cross-sectional view of a time domain reflectometry waveguide structure of this disclosure and a curve showing the signal intensity of a reflection signal before the detection made by the time domain reflectometry waveguide structure takes place respectively, this disclosure provides a time domain reflectometry waveguide structure 1 comprising a control module 10, a waveguide sensor 20, a protective cover 30 and an insulator 40. The control module 10 is electrically coupled to the waveguide sensor 20, and the protective cover 30 is sheathed on a portion of the waveguide sensor 20, and the insulator 40 covers the waveguide sensor 20 and the protective cover 30.

The control module 10 is provided for transmitting a sensing signal and receiving a reflection signal fed back from the sensing signal. In this embodiment, the sensing signal is an electromagnetic wave, and the reflection signal with a signal value is reflected when the sensing signal passes through the transmission interface. Preferably, the control module 10 further comprises a coaxial cable 11, and the waveguide sensor 20 is electrically coupled to the control module 10 through the coaxial cable 11.

The waveguide sensor 20 is electrically coupled to the control module 10. In addition, the waveguide sensor 20 comprises a first probe 21 coupled to the control module 10, a curved probe 22 bent and coupled to the first probe 21, and a second probe 23 extended from the curved probe 22. In practice, the waveguide sensor 20 is comprised of an integrally formed conductor bar. In this embodiment, the second probe 23 is linearly extended from an end of the curved probe 22, and the second probe 23 is parallel to the first probe 21.

The protective cover 30 is coaxially sheathed on the first probe 21 and exposes the curved probe 22. In an embodiment of this disclosure, the protective cover 30 comprises an insulating tube 31 and a metal tube 32, wherein the insulating tube 31 is sheathed and fixed to the first probe 21, and the metal tube 32 is sheathed on the insulating tube 31. Preferably, the distance between the second probe 23 and the protective cover 30 is greater than 50 mm.

Preferably, the insulating tube 31 and the metal tube 32 have the same length. In addition, the metal tube 32 has a through hole 320 with a diameter smaller than the diameter of insulating tube 31 and greater than the diameter of the first probe 21, and the first probe 21 is passed out from the through hole 320 and coupled to the curved probe 22. Therefore, the first probe 21 is passed and coupled to the insulating tube 31, and the insulating tube 31 is plugged into the metal tube 32. The function of the protective cover 30 will be described in details below.

Since the protective cover 30 comprises a metal tube 32 capable of insulating signal interferences, therefore the sensing signal will not be interfered by external objects when the sensing signal passes through the protective cover 30, so as to prevent the attenuation of the sensing signal and allow the waveguide sensor 20 to have a long-distance sensing capability. For example, when the waveguide sensor 20 is transported from an environment (such as water) with a high dielectric coefficient to an environment (such as soil or sludge) with a low dielectric coefficient, a full reflection of the sensing signal between two interfaces or other interferences will not occur since the protective cover 30 is sheathed on the first probe 21. Therefore, the waveguide sensor 20 can transmit the sensing signal to an environment with a low dielectric coefficient and generate a reflection signal to compute the material level/height.

In addition, the insulator 40 is covered onto the waveguide sensor 20 and the protective cover 30. In this embodiment, both ends of the insulator 40 are a proximal end 41 and a remote end 42 respectively, and the proximal end 41 and the remote end 42 are closed ends for preventing external moisture or rain from entering. Further, the remote end 42 keeps a distance from an end surface of the protective cover 30, and the curved probe 22 is disposed between the end surface of the protective cover 30 and the remote end 42. In practice, the insulator 40 is made of an engineering plastic such as polytetrafluoroethene (PTFE), polyether ether ketone (PEEK), or polyvinylidene fluoride (PVDF), but not limited to such materials only.

Preferably, the insulator 40 is a cylinder, and the insulator 40 has a diameter increasing with the diameter of the waveguide sensor 20. In other words, the diameter of the insulator 40 is directly proportional to the diameters of the first probe 21, the curved probe 22 and the second probe 23. When the diameter of the first probe 21, the curved probe 22, or the second probe 23 increases, the diameter of the insulator 40 also increases, so that the waveguide sensor 20 has an appropriate impedance value. It is noteworthy that when the insulator 40 is made of a different material, the diameter of the insulator 40 is different. In an embodiment of this disclosure, the waveguide sensor 20 and the insulator 40 have an impedance value approximately equal to 50 ohms, but this disclosure is not limited to this value only.

With reference to FIG. 1B for a curve showing the signal intensity of a reflection signal before the detection made by a time domain reflectometry waveguide structure 1 of this disclosure takes place, a sensing signal of the time domain reflectometry waveguide structure 1 passes through the air, wherein Point a indicates the value of the reflection signal when the sensing signal is transmitted to Point A of FIG. 1A.

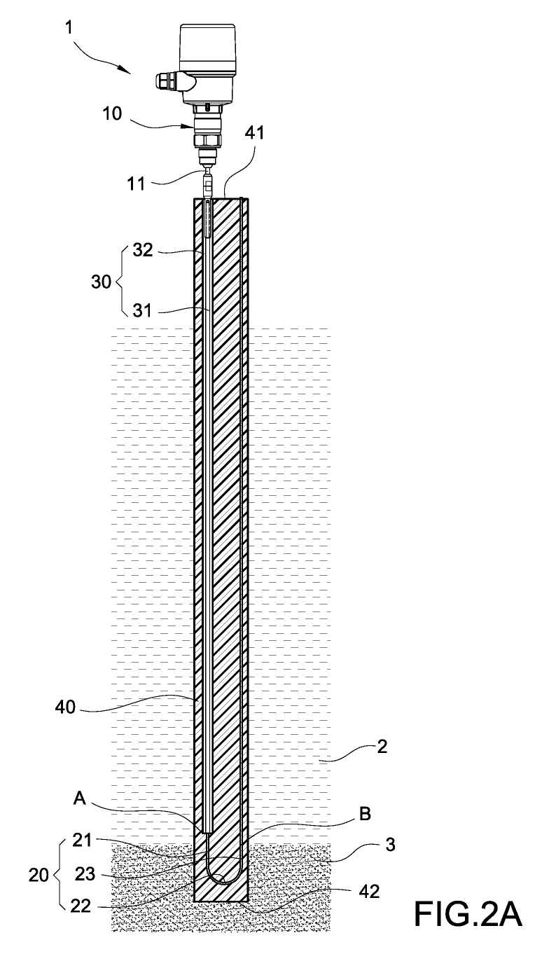

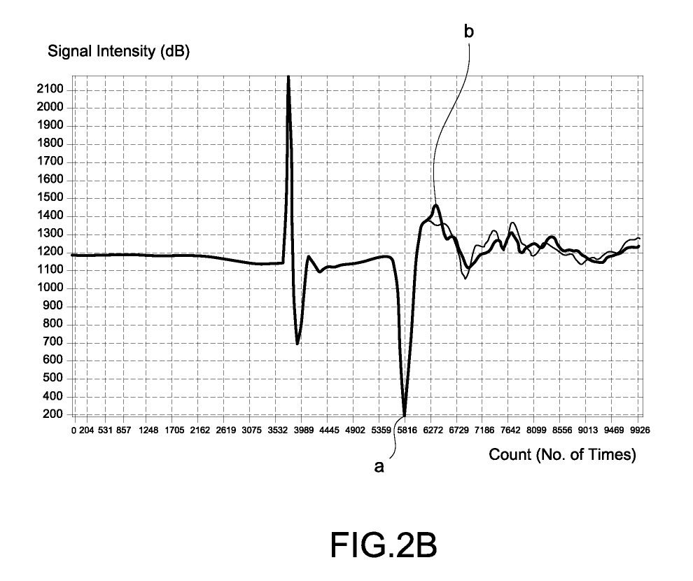

With reference to FIGS. 2A and 2B for a first schematic view of a time domain reflectometry waveguide structure of this disclosure and a curve showing the intensity of a reflection signal of the time domain reflectometry waveguide structure respectively, the time domain reflectometry waveguide structure 1 as shown in FIG. 2A is installed in a first medium 2 (which is a liquid such as water) and a second medium 3 (which is an object such as sludge) for detecting the material level/height of the first medium 2 and the second medium 3. Preferably, the first medium 2 has a dielectric coefficient greater than that of the second medium 3.

With reference to FIG. 2B for a curve showing the intensity of the reflection signal when the sensing signal of the time domain reflectometry waveguide structure 1 passes through the first medium 2 and the second medium 3, Point b indicates the value of the reflection signal when the sensing signal is transmitted to Point B of FIG. 2B. In other words, this disclosure can obtain the material level/height of the second medium 3 through the computation of the travel time at Point B of FIG. 2B. It is noteworthy that the method of calculating the material level/height by the travel time of the reflection signal is a prior art and not the main point of this disclosure, and thus will not be described in details.

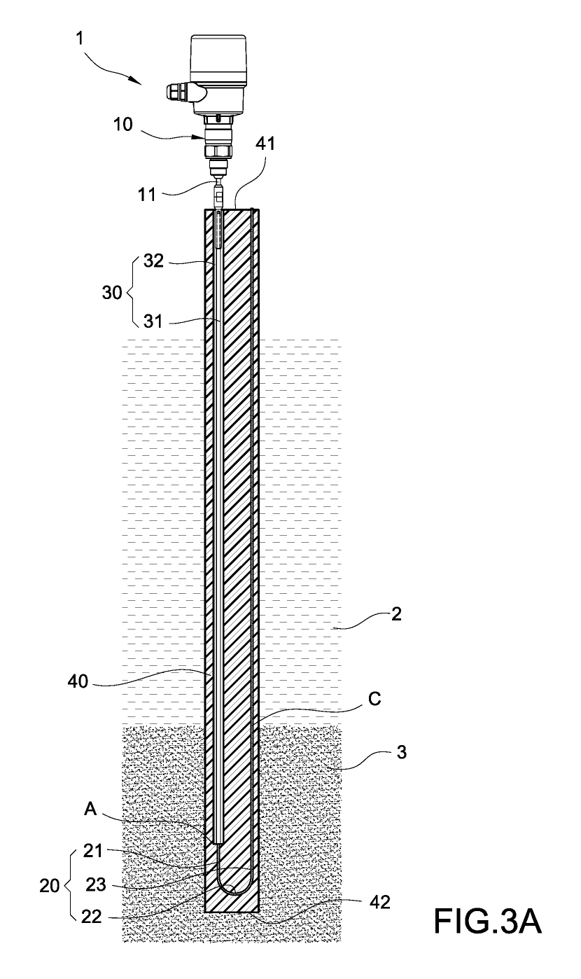

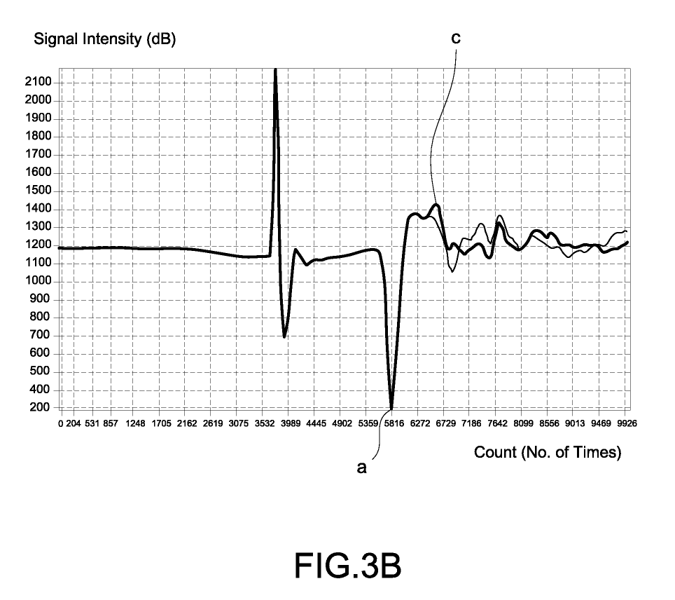

With reference to FIGS. 3A and 3B for a second schematic view of using a time domain reflectometry waveguide structure of this disclosure and a curve showing the intensity of a reflection signal of the time domain reflectometry waveguide structure respectively, the time domain reflectometry waveguide structure 1 is also installed in a first medium 2 (which is a liquid such as water) and a second medium 3 (which is an object such as sludge) for detecting the material level/height of the first medium 2 and the second medium 3, and the first medium 2 has an dielectric coefficient greater than that of the second medium 3.

With reference to FIG. 3B for a curve showing the intensity of a fed-back reflection signal when the sensing signal of the time domain reflectometry waveguide structure 1 passes through the first medium 2 and the second medium 3, Point c refers to the value of the reflection signal when the sensing signal is transmitted to Point C of FIG. 3B. In other words, this disclosure calculates the travel time of Point C of FIG. 3B to obtain the material level/height of the second medium 3.

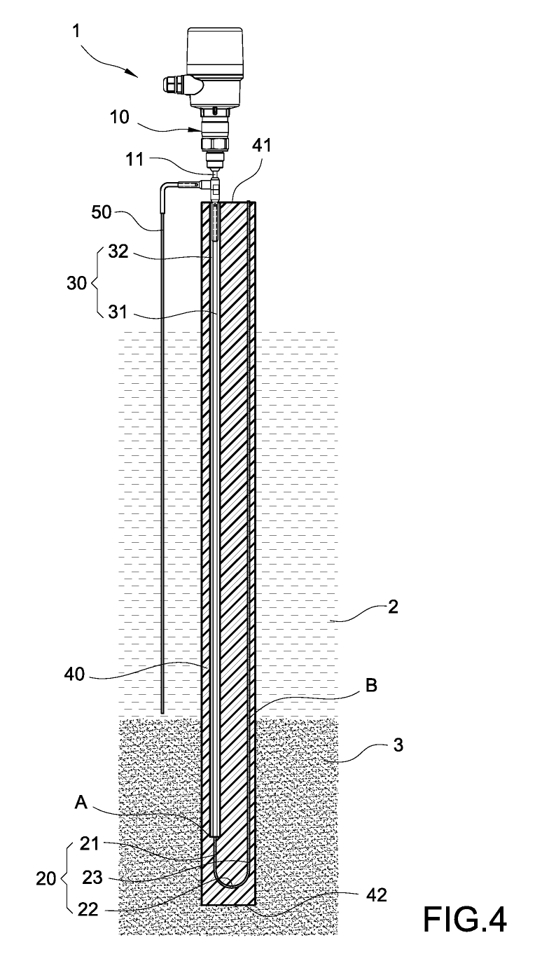

With reference to FIG. 4 for a time domain reflectometry waveguide structure in accordance with a second embodiment of this disclosure, this embodiment is substantially the same as the previous embodiment, except that the time domain reflectometry waveguide structure 1 of this embodiment further comprises a reference probe 50 in addition to the control module 10, the waveguide sensor 20, the protective cover 30 and the insulator 40. The reference probe 50 is electrically coupled to the control module 10, and the reference probe 50 is exposed from the insulator 40 and disposed parallel to an edge of the first probe 21, and the sensing signal is selectively transmitted to the waveguide sensor 20 or the reference probe 50.

In FIG. 4, when the sensing signal is transmitted to the reference probe 50, the detected reflection signal may be used for monitoring the material level/height of the first medium 2. After the sensing signal passes through the reference probe 50, the curve of the reflection signal may be used as a reference for comparison to facilitate the future related computation.

While this disclosure has been described by means of specific embodiments, numerous modifications and variations could be made thereto by those skilled in the art without departing from the scope and spirit of this disclosure set forth in the claims.

What is claimed is:

1. A time domain reflectometry waveguide structure (1), comprising:
a control module (10), for transmitting a sensing signal and receiving a reflection signal fed back from the sensing signal;
a waveguide sensor (20), electrically coupled to the control module (10), and including a first probe (21) coupled to the control module (10), a curved probe (22) bent and coupled to the first probe (21) and a second probe (23) extended from the curved probe (22);
a protective cover (30), coaxially sheathed on the first probe (21) and exposing the curved probe (22), and the sensing signal passing through the protective cover (30) and out from the first probe (21) without being interfered, and then transmitted to the curved probe (22) and the second probe (23) to obtain the reflection signal; and
an insulator (40), covered onto the waveguide sensor (20) and the protective cover (30).

2. The time domain reflectometry waveguide structure according to claim 1, wherein the control module (10) further includes a coaxial cable (11), and the waveguide sensor (20) is electrically coupled to the control module (10) through the coaxial cable (11).

3. The time domain reflectometry waveguide structure according to claim 1, wherein the second probe (23) is linearly extended from an end of the curved probe (22) and parallel to the first probe (21).

4. The time domain reflectometry waveguide structure according to claim 3, wherein the second probe (23) and the protective cover (30) have a distance greater than 50 mm apart from each other.

5. The time domain reflectometry waveguide structure according to claim 1, wherein the waveguide sensor (20) is comprised of an integrally formed conductor bar.

6. The time domain reflectometry waveguide structure according to claim 1, wherein the protective cover (30) includes an insulating tube (31) and a metal tube (32), and the insulating tube (31) is sheathed and fixed on the first probe (21), and the metal tube (32) is sheathed on the insulating tube (31).

7. The time domain reflectometry waveguide structure according to claim 6, wherein the insulating tube (31) and the metal tube (32) have the same length, and the metal tube (32) has a through hole (320) with a diameter smaller than the diameter of the insulating tube (31) and greater than the diameter of the first probe (21), and the first probe (21) is passed out from the through hole (320).

8. The time domain reflectometry waveguide structure according to claim 1, wherein the insulator (40) have both ends being a proximal end (41) and a remote end (42) respectively, and the remote end (42) keeps a distance from an end surface of the protective cover (30), and the curved probe (22) is disposed between an end surface of the protective cover (30) and the remote end (42).

9. The time domain reflectometry waveguide structure according to claim 1, wherein the insulator (40) is a cylinder, and the insulator (40) has a diameter increases with the diameter of the first probe (21), the diameter of the curved probe (22), and the diameter of the second probe (23).

10. The time domain reflectometry waveguide structure according to claim 1, further comprising a reference probe (50) electrically coupled to the control module (10) and exposed from the insulator (40), and disposed parallel to an edge of the first probe (21), and the sensing signal being selectively transmitted to the waveguide sensor (20) or the reference probe (50).
